(19) United States
(12) Patent Application Publication
(10) Pub. No.: US 2025/0353660 A1
(43) Pub. Date: Nov. 20, 2025

(54) Dispenser, Method and Cleaning System for Engine Valves

(71) Applicant: B'LASTER LLC, Valley View, OH (US)

(72) Inventors: Theodore Bradley, North Ridgeville, OH (US); Chung Hsiao, San Gabriel, CA (US); Randy M. Pindor, Fort Lauderdale, FL (US); Gregory L. Skillicorn, Akron, OH (US)

(73) Assignee: B'LASTER LLC, Valley View, OH (US)

(21) Appl. No.: 19/201,582

(22) Filed: May 7, 2025

Related U.S. Application Data
(60) Provisional application No. 63/647,417, filed on May 14, 2024.
(60) Provisional application No. 63/715,406, filed on Nov. 1, 2024.

(51) Int. Cl. B65D 83/14; B65D 83/28; F02B 77/04

(52) U.S. Cl. CPC B65D 83/14; B65D 83/28; F02B 77/04; F02B 2077/045

(57) ABSTRACT

A dispenser, method and system using a pressurized canister of cleaner for removing deposits from GDI engine valves including components such as an external housing having an actuator including a valve for engaging a valve stem of the canister, a button trigger for activation of the valve and valve stem by a user, and a trigger return spring, to bias the button trigger out of engagement with the valve, an outlet for attachment to a flexible delivery conduit having a support wire guide, where the delivery conduit is wrapped around the external housing during storage, and during operation by a single individual user extends for a length from the vehicle driver seat through an open window or door, under the open hood for engagement with the vehicle engine intake manifold supported on a delivery conduit support clip, to enable one handed operation of the system by a single user.

### CROSS-REFERENCE TO RELATED APPLICATIONS

The present application claims the priority benefit to U.S. Provisional Patent Application Nos. 63/647,417 filed May 14, 2024 and 63/715,406 filed Nov. 1, 2024, the entireties of which are incorporated herein by reference.

### FIELD OF INVENTION

The present disclosure relates to a dispensing apparatus or dispenser and a system for cleaning a vehicle internal combustion engine via an air intake manifold.

### BACKGROUND OF THE INVENTION

Gasoline direct injection (“GDI”) engines typically utilize fuel injection technology that over time and operation leaves various deposits on engine intake valves. While the fuel injection technology has advantages and efficiencies, it produces carbon and other deposits that build up on intake valves, reducing airflow through the valves, and consequently reducing engine performance, including higher emissions, lower power output or horsepower, lower fuel economy, and generally rough engine performance. Additional damage may also result in the event the built up deposits break off and result in damage to other components, or other performance reductions, as they move through the system. As a result, there is a need to remove the dirt and deposits.

Prior methods to physically clean intake valves require professional services and are expensive. Numerous chemical cleaners are known for addressing concerns surrounding cleaning of the intake valves, for example, U.S. Pat. Nos. 2,943,945 and 8,627,845. In addition to chemical cleaners, dispensing devices or dispenser systems are also available for enabling vehicle owners to apply the chemical cleaners to the vehicle intake valves. For example, U.S. Pat. Nos. 10,267,227, 11,585,267 and 11,773,770 provide alternative solutions to the cleaners and dispensers. However, such dispensers and cleaners each have disadvantages, whether the problems relate to environmental concerns or to the difficulties encountered by a single person attempting to use the dispensers to administer the cleaners to their own vehicle in their own garage or driveway, improvements are needed. Improved dispensers and cleaners to enable the single-handed application of cleaners for removing dirt and deposits from intake valves are needed to assist vehicle owners with ongoing engine maintenance.

### SUMMARY OF THE INVENTION

This application provides a dispenser and a system and method for cleaning engine deposits from intake valves in a GDI engine. The dispenser includes an external housing for storage of a delivery conduit and having an outlet for fluid connection with and guidance of the delivery conduit during operation. The external housing also contains actuator components forming a connection to a pressurized canister containing the cleaner, and for enabling release of cleaner from the canister. The external housing has a base for snap-on attachment to the top of the pressurized canister over a valve stem enabling fluid flow from the canister upon user activation of the actuator components. A surface extending outwardly from the base of the external housing provides a shelf or base shelf for supporting the delivery conduit. The shelf may include a substantially circular wall extending upward from the shelf, or a substantially conically shaped wall extending upward from the shelf. Each type of shelf enables the delivery conduit to be wrapped around or encircle the wall of the external housing for storage. A delivery conduit of at least approximately 7 feet, and preferably at least approximately 10 feet is provided.

The delivery conduit has a cleaner or fluid receiving end and a cleaner or fluid delivery end. The cleaner delivery end engages and supports a delivery conduit support clip for securing the delivery conduit engaged within the intake manifold. In any preferred embodiment, the delivery conduit is a flexible elongate delivery conduit configured to enable storage surrounding or wrapping around the external housing and for desired positioning of the flexible elongate delivery conduit to the engine intake manifold. The delivery conduit may be delivered to the consumer engaged with the actuator components or may be connected together by the consumer prior to use. A lock is also provided to ensure the product is not dispensed unintentionally or by a child. The dispenser further includes a cap or overcap for use during shipment and storage, for engaging and covering the external housing, delivery conduit and support clip.

The elongate length and flexible structure of the delivery conduit, together with the delivery conduit support clip, enables delivery of the cleaner to the engine air intake by a single individual user operating the dispenser with one hand while seated behind the wheel of the user's vehicle in the driver's seat location within the vehicle passenger compartment. Operation of the system and method, including the dispenser and cleaner within the canister, may be conducted by the user positioned at a location inside the vehicle, while seated in the driver's seat, such that operation of the vehicle by the user is enabled during application of the cleaner using the dispenser with the present system and method.

To use the present system and method, the elongate flexible delivery conduit and support clip are first uncovered by removing the overcap engaged on the external housing. The support clip may then be engaged on the fluid delivery end of the delivery conduit, or the support clip may be provided pre-assembled supported on the delivery conduit under the overcap. The delivery conduit and support clip are then unwound from the storage position around the shelf of the external housing. Once extended from the external housing, the fluid delivery end of the delivery conduit and support clip may be readily passed by the user from inside the vehicle through the open driver door or window, under the open hood to the desired location near the engine intake manifold. The canister of vehicle engine valve chemical cleaner interconnected with the delivery conduit remains near a driver seat location within the vehicle passenger compartment of the vehicle. The user then secures the support clip with the delivery conduit to the engine air intake manifold in a position and location for receiving fluid cleaner from the fluid delivery end of the delivery conduit into the intake manifold. The user may then return to the driver's seat location, grasping the canister of vehicle engine valve chemical cleaner with one hand, and with a finger on the activation button trigger. With a second hand, the user can then start the vehicle engine and rev the vehicle engine to higher RPMs, at least 2000-3500 RPM or higher, while at the same time depressing the dispenser activation button trigger and delivering cleaner to the engine intake manifold and the dirty valves.

The delivery conduit support clip includes a body having a top leg and a bottom leg interconnected by a web portion. Free ends of each of the top leg and bottom leg, located opposite the web portion, are configured in close proximity for securing engagement between them on a portion of the air intake manifold. The web portion and top and bottom legs are of a material sufficiently flexible to enable the legs to be moved with respect to the web portion for flexing and securing the support clip on to the vehicle. Openings are provided on one leg, such as the top leg, of the support clip for supporting engagement with the delivery conduit.

The actuator components secured within the external housing include a valve for engaging and receiving cleaner from the pressurized canister. Numerous prior art valve configurations are well known, and the present valve may be formed as an independent valve, or configured within an internal portion of a button trigger.

The system includes a pressurized canister for holding the cleaner. The canister has an interior reservoir, and an outlet port in fluid communication with the interior reservoir. The delivery end of the delivery conduit is in fluid communication with the fluid outlet of the dispenser external housing, and, as the system is generally a single use operation, it is preferably permanently or non-removably secured by any known technique at the fluid outlet of the external housing. The cleaner receiving end of the delivery conduit is in fluid communication with the fluid outlet from the external housing via the outlet port of the canister and connected valve passage, through which the cleaner flows from the canister.

The cleaner of the present system may include several components, such as detergents, water and a propellant. In the present embodiment of the cleaner, the water soluble nature of several ingredients provide advantages to the cleaner within the system. Testing protocols indicate that the amount of water used within the cleaner provides, in effect, a type of steam cleaning treatment to the valves, to assist with removal of deposits from the surface of an intake valve and thereby improve engine performance.

The present cleaner for dispensing from within the pressurized canister via the dispenser may include well known commercial cleaners such as POWERZOL®, available from The Lubrizol Corporation. Water in an amount of at least about 2.0% by weight may also be provided to sufficiently enable the creation of steam during operation of the method and system to assist with cleaning surfaces of the intake valves. Finally, a propellant, such as NP-70 may also be provided.

### BRIEF DESCRIPTION OF THE DRAWINGS

Embodiments will now be described, by way of example only, with references to the accompanying drawings in which:

FIG. 1 is a schematic perspective view of a dispenser covered by a cap containing the delivery conduit and delivery conduit support clip, all in a storage position on a canister containing the cleaner for cleaning an intake system of a GDI engine via the engine air intake manifold.

FIG. 2 is a partial schematic perspective view of the dispenser of FIG. 1 with the cap removed prior to unwinding of the delivery conduit.

FIG. 3 is a partial rear view of an alternate embodiment of a dispenser on a canister in the system provided.

FIG. 3D is a partial cut-away view of the dispenser and canister of FIG. 3 taken along the line D-D.

FIG. 4 is a transparent partial right side view of the dispenser and canister of the system, highlighting the internal aspects of the actuator components of the dispenser, delivery conduit with a wire guide, and canister.

FIG. 5 is a partial front view of the dispenser, delivery conduit and canister of FIG. 4.

FIG. 6 is a partial rear view of the dispenser, delivery conduit and canister of FIG. 5.

FIG. 6A is a cut-away view of the dispenser and canister taken along the line A-A of FIG. 6.

FIG. 7 is a schematic, partial, front bird's eye perspective view of the dispenser, delivery conduit and delivery conduit support clip on a canister in a position ready for attachment to an air intake manifold prior to activation and operation of the system by a single user.

FIG. 8 is a schematic, partial, rear view of the system of FIG. 7.

FIGS. 9 and 10 are schematic, partial top and perspective front views, respectively, of an alternate dispenser, delivery conduit and delivery conduit support clip arrangement.

FIG. 11 is a photograph illustrating the state of a dirty engine valve body with deposits on the right hand side of the photograph, and the state of a clean engine valve body on the left hand side of the photograph following treatment with a single use canister of the present system.

FIG. 12 is a perspective front view showing the dispenser, cleaner and system for cleaning engine deposits from intake valves in a GDI engine prior to removal of an overcap from the canister.

FIG. 13 is a perspective front view of the dispenser, cleaner and system of FIG. 12 with the overcap removed.

FIG. 14 is a side cut-away view of the dispenser showing the external housing and actuator components secured to a canister and covered by an overcap.

FIG. 15 is an exploded front perspective view of the dispenser, cleaner and system of FIG. 12 with the overcap removed, the delivery conduit secured to the actuator components, and with the support clip secured in position on the delivery conduit for attachment to an intake manifold prior to use.

FIG. 16 is an exploded rear perspective view of the dispenser, cleaner and system of FIG. 15.

FIG. 17 is an exploded left side view of the dispenser, cleaner and system of FIG. 15.

FIG. 18 is an exploded right side view of the dispenser, cleaner and system of FIG. 15.

FIG. 19 is an exploded front view of the dispenser, cleaner and system of FIG. 15.

FIG. 20 is an exploded rear view of the dispenser, cleaner and system of FIG. 15.

FIG. 21 is an exploded top view of the dispenser, cleaner and system of FIG. 15.

FIG. 22 is an exploded bottom view of the dispenser, cleaner and system of FIG. 15.

FIG. 23 is a schematic view of a user with the dispenser in position and ready for one-handed operation of the method and system for application of the cleaner to the engine air intake manifold.

### DETAILED DESCRIPTION OF THE EMBODIMENTS

While the subject matter of this application may be embodied in many different forms, described here are preferred embodiments as well as alternate embodiments, with the understanding that the present disclosure is to be considered as an exemplification of the principles described and is not intended to limit the broad aspects described to the embodiments illustrated. It will be understood that the disclosure may be embodied in other specific forms without departing from the spirit or central characteristics thereof. For context, the orientation of the components may be referred to by directions (e.g., top, bottom, right, left, etc.) as shown in the figures. Likewise, a prime designation may be used to identify alternate forms of similar features. Those skilled in the art will recognize that during use these directions may be changed without changing the relationship between components. The present embodiment, therefore, is to be considered in all respects as illustrative and not restrictive, and not to be limited to the details given herein.

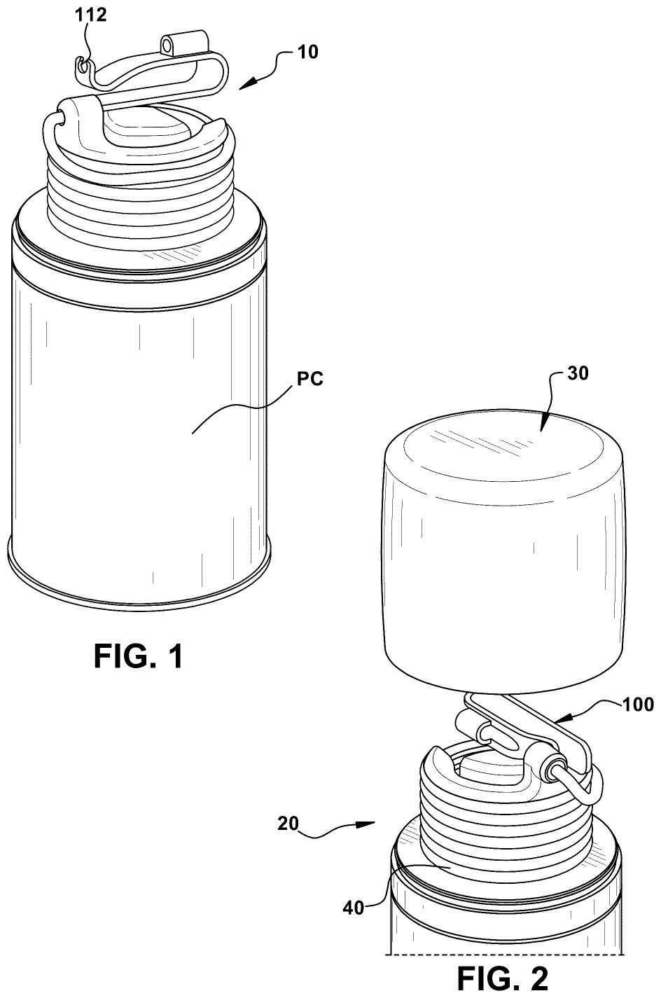

As shown in FIGS. 1-2, 9-10 and 13, the dispenser includes an external housing 20 for storage of a delivery conduit 40 and having a fluid outlet 22 for fluid connection with, and guidance of, the delivery conduit during operation. Actuator components 60 within the external housing 20 form a preferably permanent or non-removable connection, to a pressurized canister PC containing the cleaner C, and for enabling release of cleaner from the canister. Such attachments may include adhesives, molding, crimping, press-fit engagement or any known permanent or non-removable connections. The external housing has a base 24 for snap-on attachment to the top T of the canister PC over a valve stem 62 enabling fluid flow from the canister upon activation of the actuator components 60. A surface extending outwardly from the base 24 of the external housing provides a shelf or base shelf 26 for supporting the delivery conduit 40. The shelf 26 may include a substantially circular wall 28 extending upward from the shelf, or a substantially conically shaped wall 28′ extending upwardly from the shelf. Each type of shelf 26, 26′ enables the delivery conduit 40 to be wrapped around or encircle the wall of the external housing for storage. A delivery conduit of at least approximately 7 to 10 feet is preferably provided. A delivery conduit support clip 100 is provided either pre-assembled on the delivery conduit 40, or for attachment by the user.

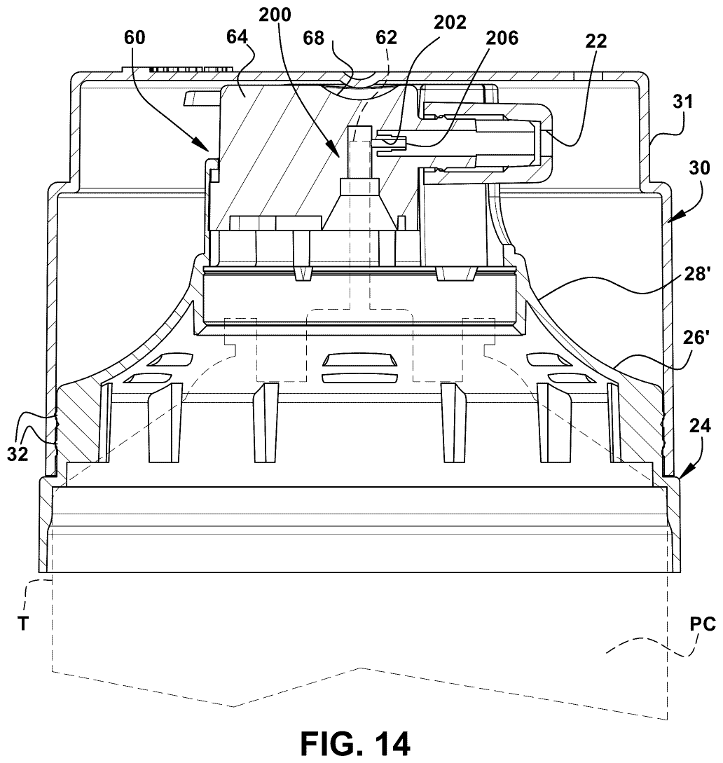

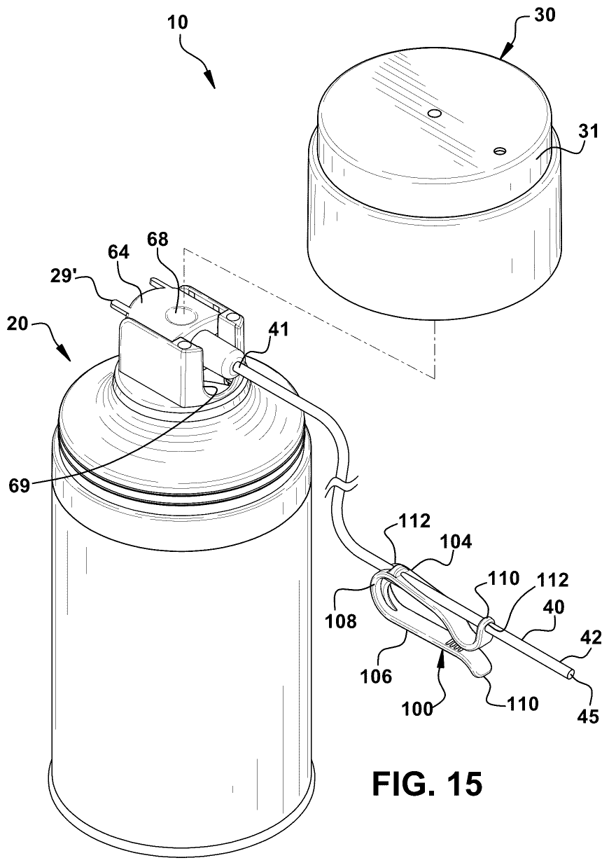

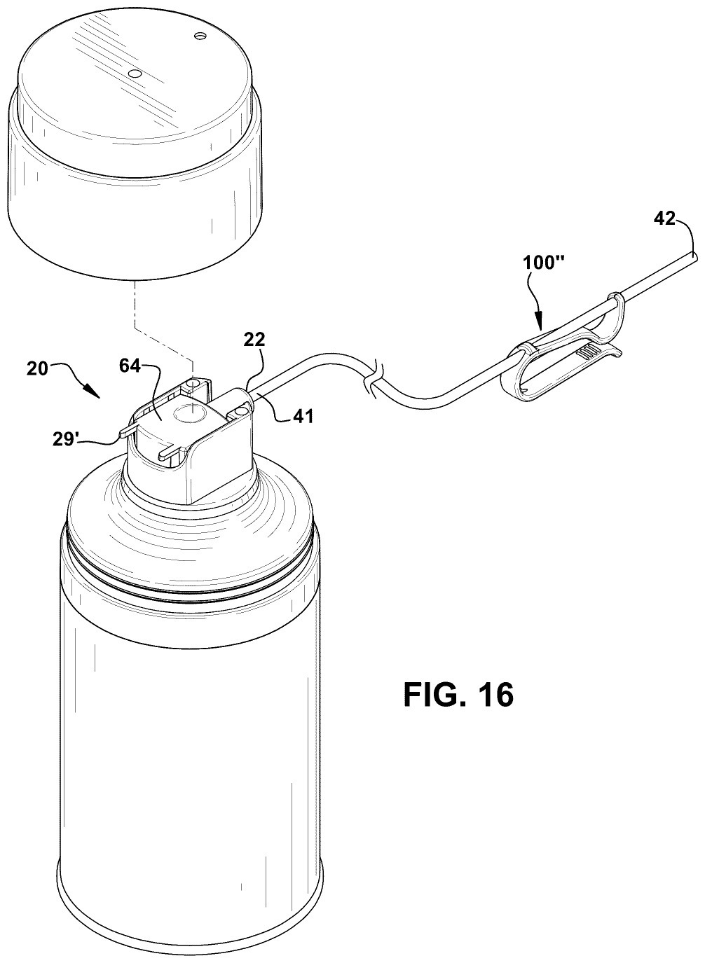

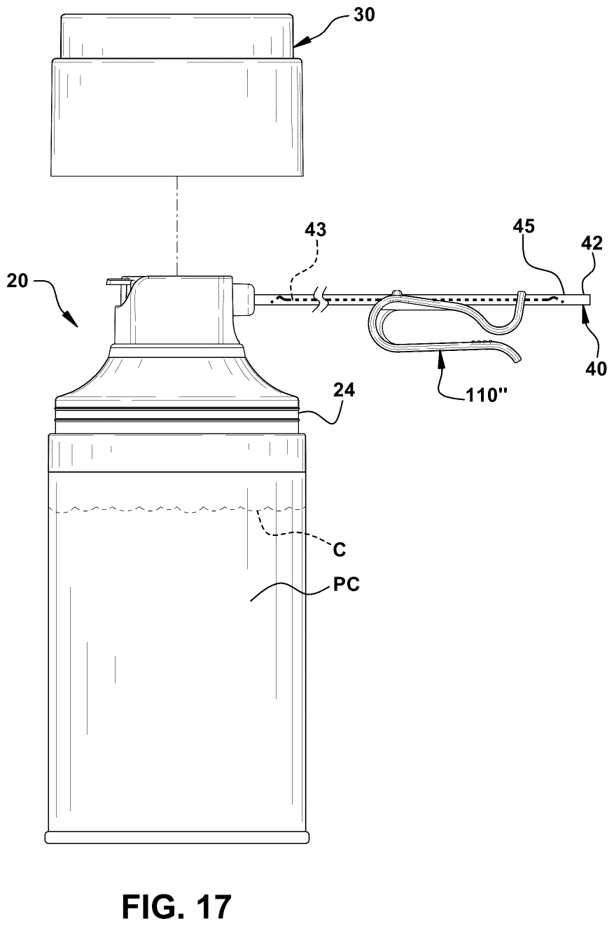

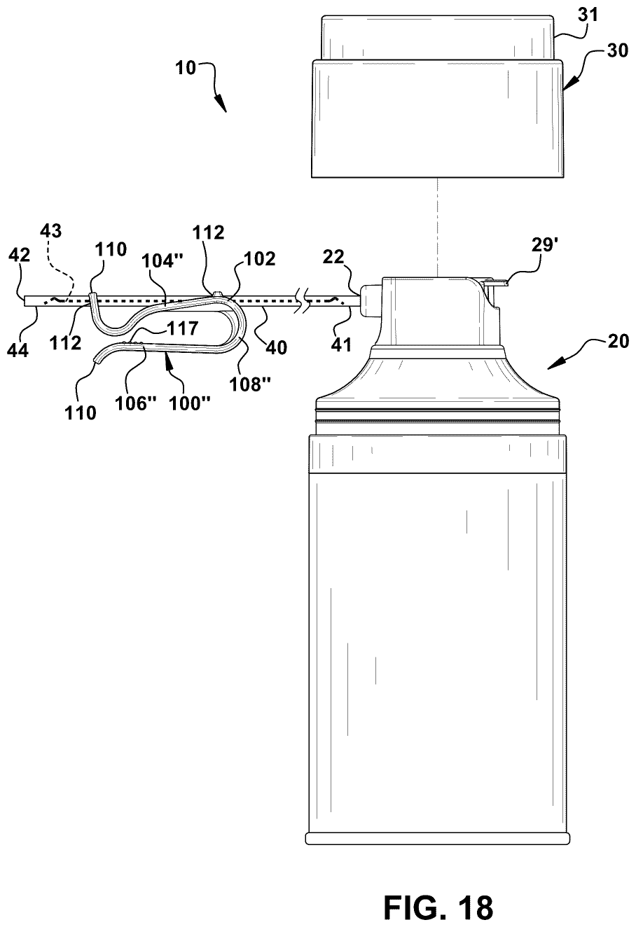

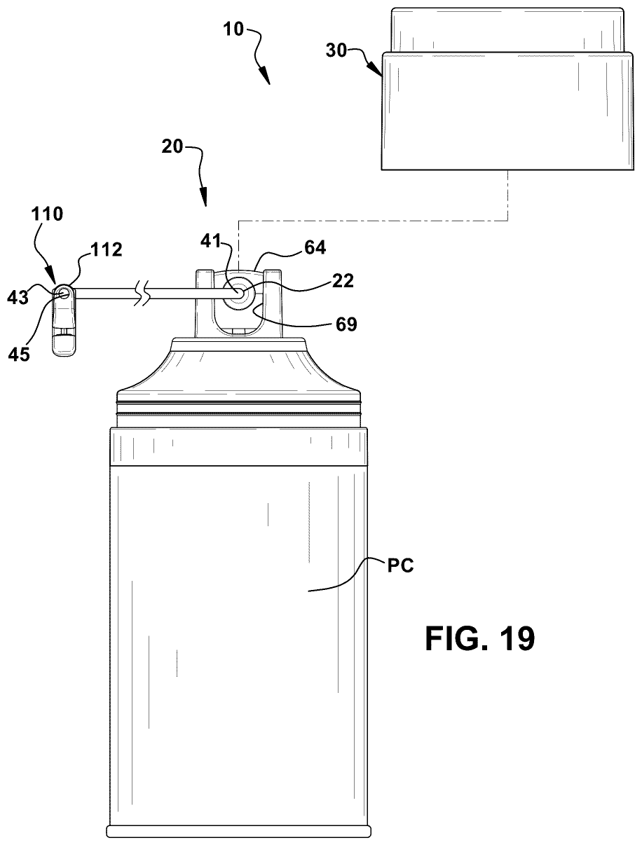

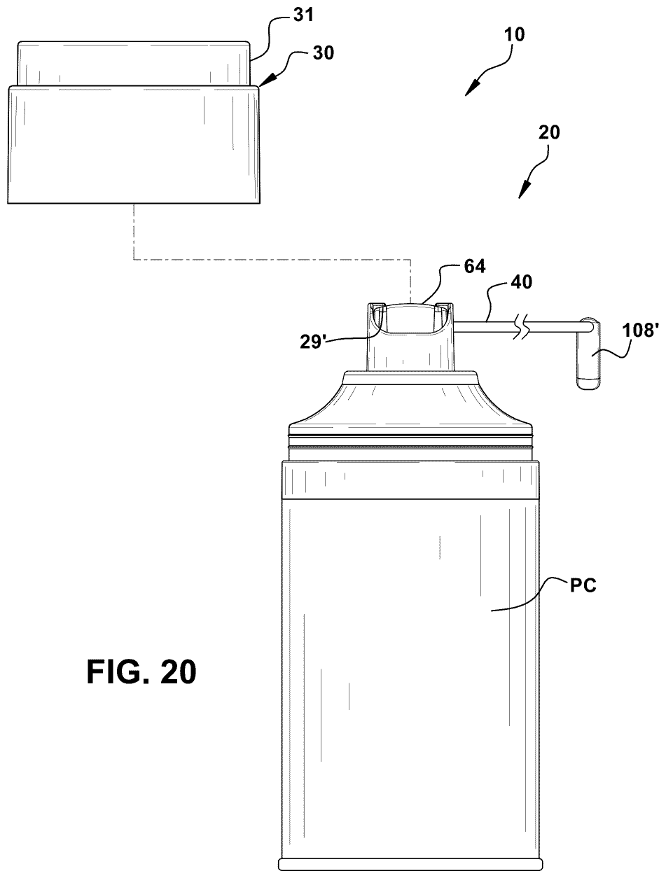

The dispenser may further include a cap or overcap 30 for use during shipment and storage, for engaging and covering the external housing 20, the delivery conduit 40 having a cleaner receiving end 41 and a cleaner delivery end 42, and the delivery conduit support clip 100, as in FIGS. 1-2. As shown in FIGS. 15 to 20, the overcap may include a top ledge 31, with a reduced diameter as compared to the portion of the overcap engaged with the external housing. The top ledge 31 enables convenient nested stacking during shipment and retail sales of the product. As shown in FIGS. 14 to 18, ridges 32 are provided at the base 24 of the external housing below the shelf 26, for press-fit or snap-on engagement of the overcap 30 with the external housing 20. In any preferred embodiment, the delivery conduit 40 is configured to enable storage surrounding or wrapping around the external housing and for desired positioning of the elongate delivery conduit with respect to an engine intake manifold under the open hood of the vehicle with the engine valves to be cleaned. The delivery conduit 40 may be delivered to the consumer engaged with the external housing 40 and or may be connected together by the consumer prior to use, where the embodiment does not include a permanent or non-removable connection. A lock is also provided to ensure the product is not dispensed unintentionally or by a child.

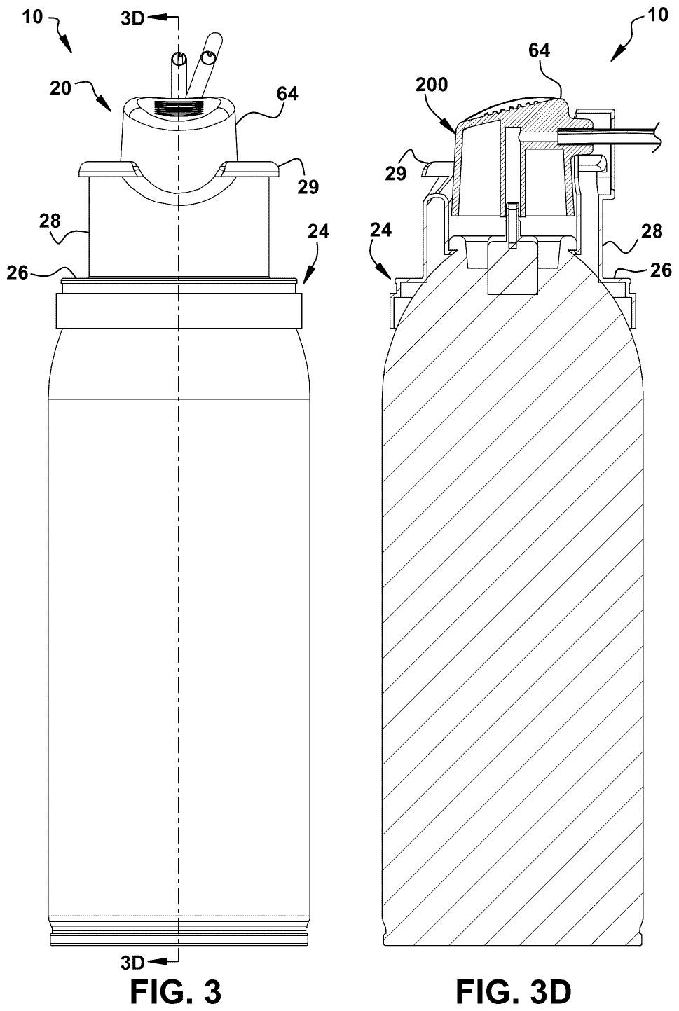

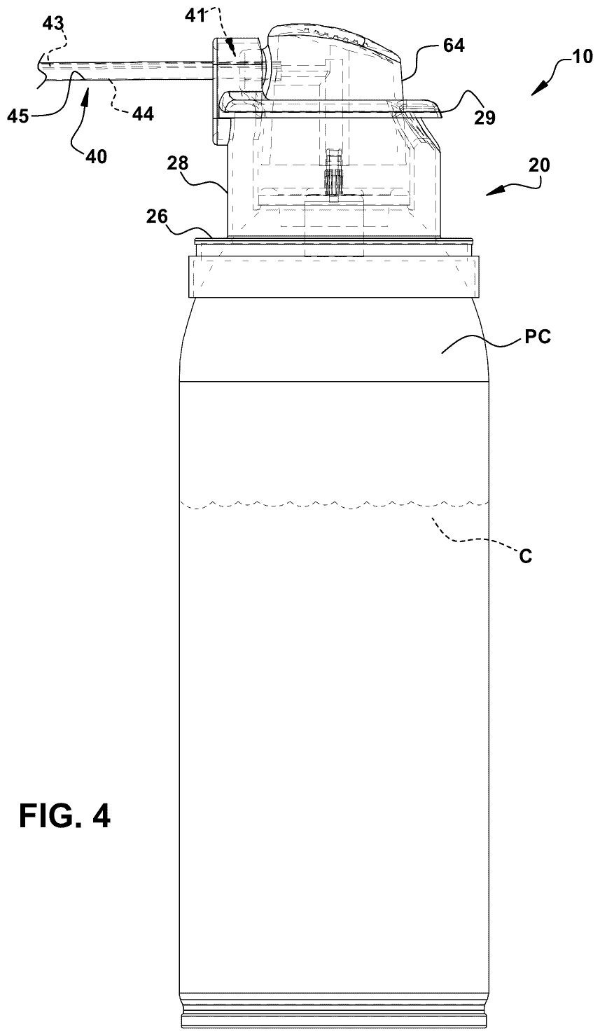

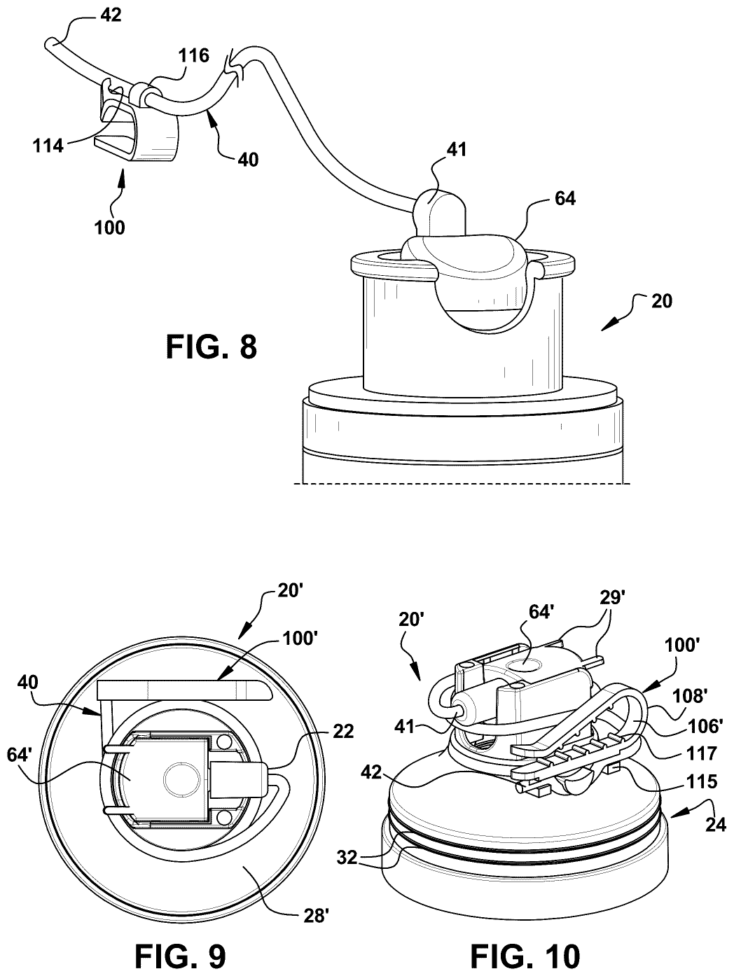

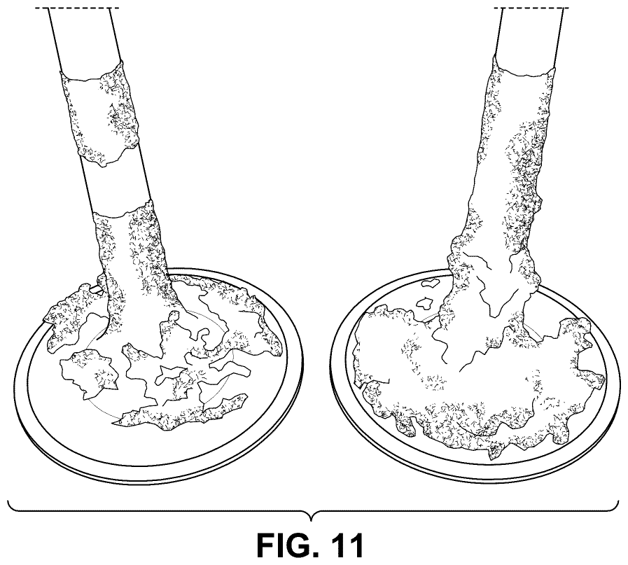

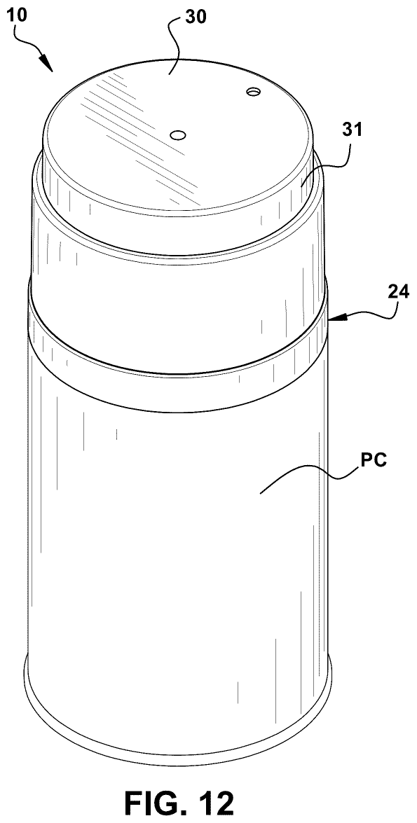

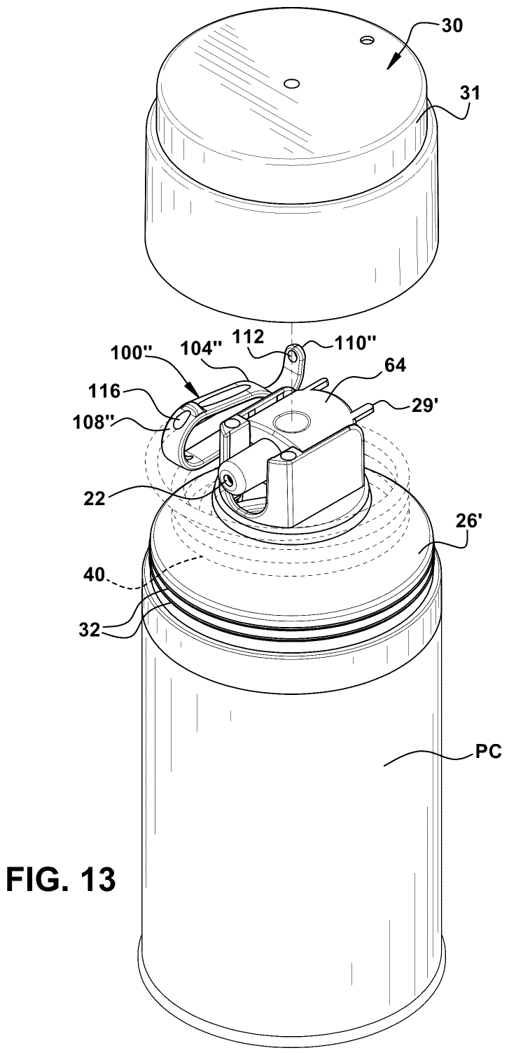

The circular wall 28 has an outer diameter of between 1.5 and 3.5 inches, and preferably approximately about 2.5 inches for engagement with and surrounded by the delivery conduit 40 during storage. A top shelf 29 may optionally also be provided spaced from and above the base shelf 26 of the external housing, as in FIGS. 1 to 8. The base shelf preferably extends approximately 1.5 inches above the base. The top shelf 29 extends radially outward from a portion of the top of the wall 28 and enables additional confinement of the delivery conduit 40 during storage, but does not interfere with operation of the actuator components 60. Where no top shelf is provided, spaced cars 29′ may be provided extending outwardly and away from a button trigger 64 of the actuator component 60, as in FIGS. 13 to 18. Ears 29′ extending outwardly from the button trigger 64 serve to assist with capture and retention of the delivery conduit when wrapped surrounding the wall 28, 28′ during product sales, storage and delivery to the consumer. The delivery conduit is wrapped and constrained for storage between the base shelf and top shelf or spaced cars a number of times. For an approximately 7.5 foot long delivery conduit 40, for example, typically 7 wraps to at least 10 wraps may be provided around the wall.

The delivery conduit 40 is a flexible conduit preferably between at least 2 feet and 12 feet long, more preferably between at least 6 and 11 feet long, and most preferably at least approximately 10 feet in length. The flexible delivery conduit 40 may be provided with an elongate wire guide 43, either included inside a central passage 45, or embedded within a portion of a wall 44 of the delivery conduit. Manufacture of the delivery conduit 40 with an embedded wire guide 43 is typically accomplished during extrusion of the delivery conduit. The delivery conduit 40 has an internal diameter of approximately 1.6 mm, and external diameter of approximately 2.6 mm, and is preferably manufactured of a polyethylene plastic or other suitable polymer material. While the embedded wire guide 43 is preferably provided along the entire length of the delivery conduit, alternatives such as embedding a shorter length (perhaps along the central length of the delivery conduit, but leaving a gap at each end) or shorter spaced lengths of the wire guide, may alternatively be sufficient. Where the wire guide is included inside the central passage 45, the wire guide may simply be passed into and positioned inside the length of the central passage, potentially secured at either one or both ends of the delivery conduit.

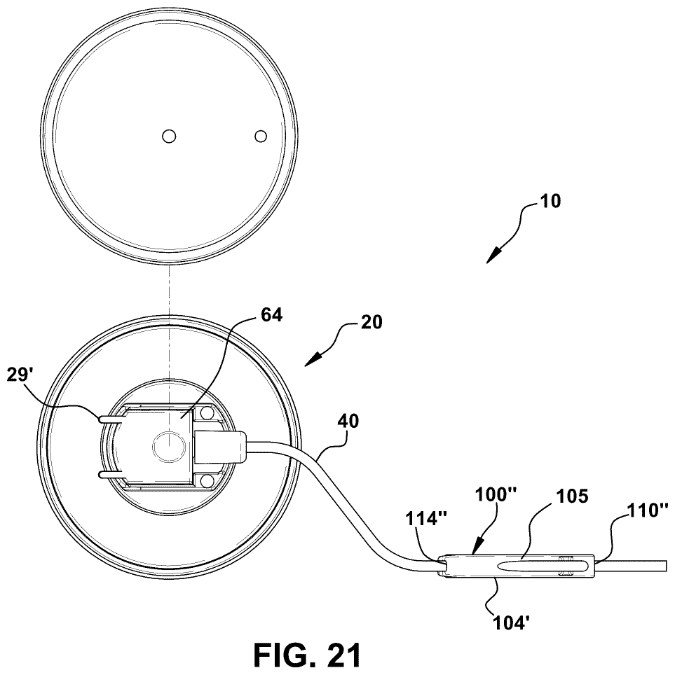

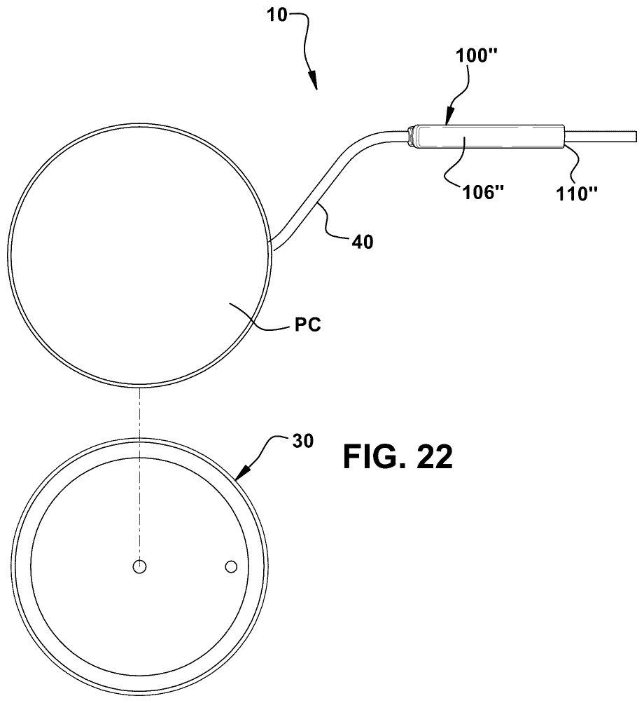

The delivery conduit support clip 100 includes a body 102 having a top leg 104 and a bottom leg 106 interconnected by a web portion 108. Free ends 110 of each of the top leg and bottom leg, located opposite the web portion 108, are configured in close proximity for securing engagement with the air intake manifold. The web portion 108 and top and bottom legs 104, 106 are of a material sufficiently flexible to enable the legs to be moved with respect to the web portion for flexing and securing the support clip 100 on to the vehicle. Openings or supports 112 are provided on one leg, such as the top leg 104, of the support clip 100 for supporting and securing engagement with the delivery conduit 40. The delivery conduit support clip 100 is preferably manufactured of a polyoxymethylene polymer material, also known as acetal, polyacetal, polyformaldehyde or POM plastic, and is a thermoplastic preferred for its stiffness, low friction, and dimensional stability, but other suitable polymer materials may be sufficient. The illustrated top leg 104 in FIGS. 1 to 8 includes a delivery conduit support 114, which may be provided as an open cradle 114 adjacent a free end 110 of the top leg to enable the delivery conduit to be snap-fit or otherwise pressed into secure engagement with the delivery conduit 40. In the embodiment of FIGS. 9-10, the bottom leg 106′ is provided with open cradle 114′ supports and an open blocking slot 115 for securing engagement of the fluid delivery end 42′ on the bottom leg of the support clip 100′. In the embodiment of FIGS. 15 to 22, the free end 110′ of the top leg 104″ may, in an alternative to an open cradle, include closed holes or openings 114″ through which the delivery conduit may be threaded for securing the delivery conduit to the support clip 100″. In the embodiment of FIGS. 15-22, the free end 110″ of the top leg 104″ is curved upward and away from the bottom leg 106″, and a top surface 105 of the top leg may include a cradle for supporting the delivery conduit engaged with the top leg, or an opening adjacent the web portion through which the delivery conduit may be threaded. Additionally, or alternatively, the top leg may include a hose surround 116 spaced from the cradle toward the web portion for surrounding and supporting the fluid delivery end of the delivery conduit. FIGS. 10 and 15 show the bottom leg 106, 106′, 106″ including serrations, or ribs 117, for engaging with the engine intake manifold to resist removal of the support clip during operation of the dispenser, system and method. The bottom leg, top leg and web portion have a generally U-shaped configuration for engaging the support clip by sliding the clip and delivery conduit into engagement with the engine intake manifold in a delivery position. The design of the stiff, but still flexible and stable material of the delivery conduit support clip, enable some expansion and contraction or spring action of and between the bottom and top legs using the web portion, during engagement on the engine intake manifold.

The fluid delivery end 42 of the delivery conduit 40 is in fluid communication with the fluid outlet 22 of the dispenser external housing 20, and, as the system is generally a single use operation, it is preferably permanently or non-removably secured by any known technique at the outlet of the external housing, such as adhesive, molding or other equivalent techniques.

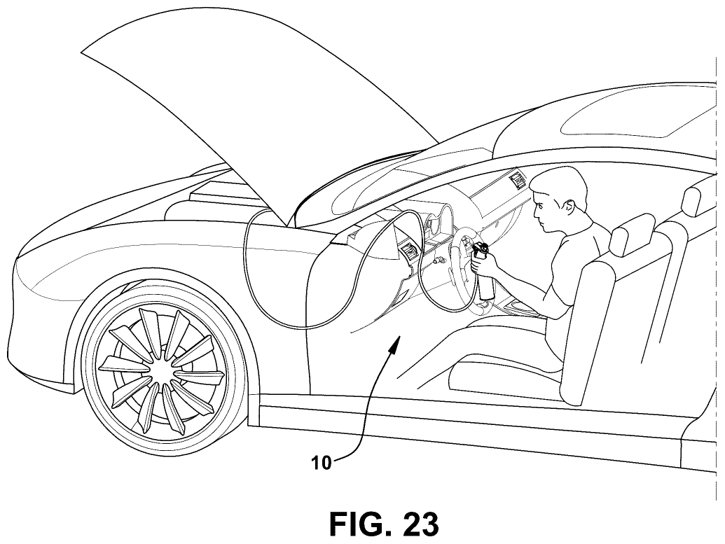

Once the delivery conduit 40 and support clip 100 are secured in the delivery position to the engine intake manifold, cleaner from the cleaner delivery end 42 of the delivery conduit is in position to spray cleaner C into the engine intake manifold upon activation of a button trigger 64 of the actuator components 60 by a single user seated behind the wheel of the vehicle in the driver seat location, as shown in FIG. 23. During operation of the system and method, a single user is able to depress the accelerator pedal to increase engine RPM, while at the same time activating the dispenser 10 using the advantageous one-handed, single-user method and system operation to deliver the cleaner C. The single use canister PC of cleaner C is generally between an 11 and 18 ounce canister. The fluid chemical vehicle engine valve cleaner C housed within the interior reservoir of the canister may be approximately 12 ounces within an 18 ounce canister also housing propellant and water.

A valve 200 forms a passage 202 configured with the valve stem 62, an inlet 204 and an outlet 206 to enable fluid communication of the cleaner C from the pressurized canister PC to the external housing outlet 22 and interconnected delivery conduit 40. The valve passage 202 receives cleaner flow from the canister PC upon operation of the button trigger 64 activated into operating engagement of a shoulder 208 on an internal portion 65 of the button trigger 64 with the valve stem 62 of the canister C to a valve open position under finger compression by a user on an external surface 66 of the button trigger and an internal trigger return spring (not shown). The external surface of the button trigger includes ribs 67 for case of operation. The actuator components 60 include the trigger return spring to bias the button trigger out of engagement with the valve stem of the canister to a closed position. The button trigger 64 with the valve passage 202 may be of any suitable shape from any suitable material, such as injection molded rigid plastic or polymer. A button trigger depression 68 is provided in the external housing 20 at a location opposite the external housing outlet 22 for fluid connection with the delivery conduit 40.

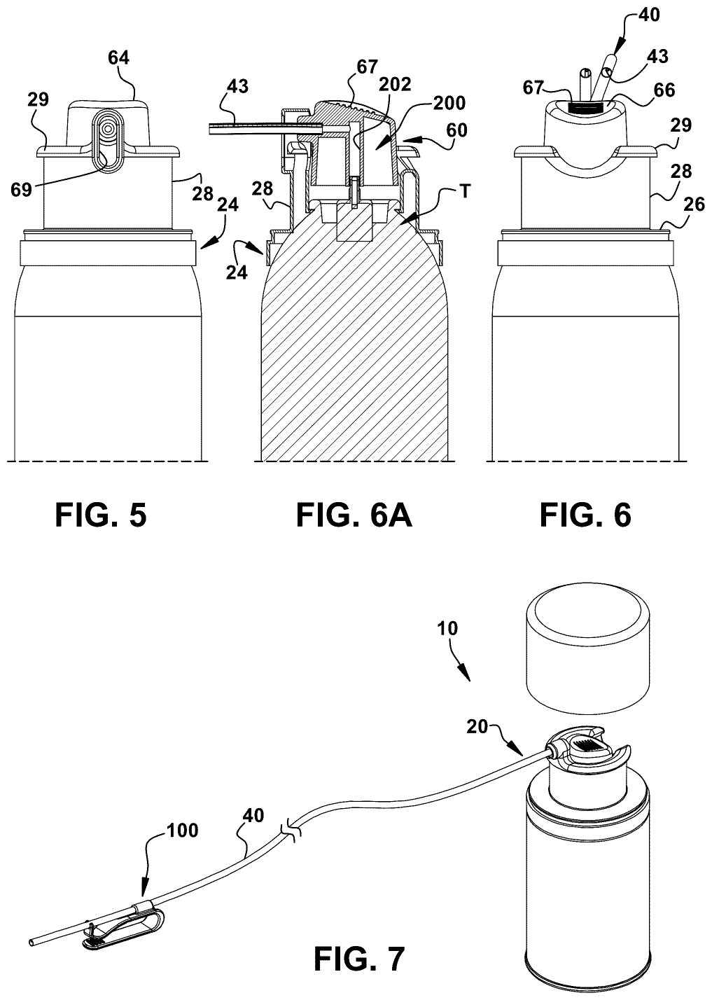

In the embodiment of FIGS. 14 to 21, a delivery conduit guide slot 69 may be formed to surround the fluid outlet 22 of the dispenser external housing 20, enabling vertical movement and guidance of the attached delivery conduit 40 within the guide slot 69 during activation of the button trigger 64 by a user. The guide slot 69 in the illustrated embodiments has a vertically oblong configuration, an open top portion, and is located at the front of the external housing 20 opposite the button trigger depression 68. In an embodiment with a top shelf 29, the guide slot interrupts the top shelf, as shown in FIG. 5. In an embodiment with extending ears 29′, the guide slot 69′ is at the front of the external housing opposite the extended cars. The delivery conduit 40 extends from the outlet 22 of the external housing 20 through the guide slot 69. Alternate configurations for the fluid outlet 22 from the external housing 20 may also be provided.

The dispenser, system and method being described are further described in the following claims, and may be varied in many ways. Such variations are not to be regarded as a departure from the spirit and scope set forth herein, and all such modifications as would be obvious to one skilled in the art are intended to be included within the scope of the configurations described.

1. A dispenser for providing a chemical engine valve cleaner, the dispenser comprising, an external housing having a fluid outlet engaged with a flexible elongate delivery conduit, wherein the flexible elongate delivery conduit is wrapped around a portion of the external housing during storage, and during operation extends for a length of at least approximately 10 feet from the fluid outlet, and a fluid delivery end of the flexible elongate delivery conduit is supported for dispensing fluid to an engine intake manifold engaged with a support clip.

2. The dispenser for providing a chemical engine valve cleaner of claim 1, wherein the support clip includes a body having a top leg and a bottom leg interconnected by a web portion in a generally U-shaped configuration for engaging the clip by sliding the clip and delivery conduit into engagement with the engine intake manifold in a delivery position for delivering chemical engine valve cleaner to the engine intake manifold, and free ends of each of the top leg and bottom leg are located opposite the web portion and configured in close proximity for securing engagement with the engine air intake manifold, and the web portion and top and bottom legs are sufficiently flexible to enable the legs to be moved with respect to the web portion for flexing and securing the support clip engaged with the flexible elongate delivery conduit on the vehicle engine air intake manifold.

3. The dispenser for providing a chemical engine valve cleaner of claim 2, wherein the support clip includes at least one support on one leg for supporting engagement with the delivery conduit, and the support is an open cradle or an opening through which the delivery conduit may be threaded for securing the delivery conduit to the support clip, and one leg includes serrations, or ribs, for engaging the engine intake manifold to resist removal from the delivery position during delivery of chemical engine valve cleaner to the engine intake manifold.

4. A support clip for a dispenser for dispensing a chemical engine valve cleaner to a vehicle engine intake manifold, the support clip including a body having a top leg and a bottom leg interconnected by a web portion in a generally U-shaped configuration for engaging the clip by sliding the clip and delivery conduit into engagement with the engine intake manifold in a delivery position for delivering chemical engine valve cleaner to the engine intake manifold, and
the support clip having a free end on each of the top leg and bottom leg, the free ends located opposite the web portion and configured in close proximity for securing engagement with the engine air intake manifold, and the web portion and top and bottom legs are sufficiently flexible to enable the legs to be moved with respect to the web portion for flexing and securing engagement of the support clip and a flexible elongate delivery conduit engaged with the support clip in a delivery position on the engine intake manifold for dispensing a chemical engine valve cleaner to clean the vehicle engine intake valves.

5. A method for cleaning vehicle engine intake valves, comprising the steps of:
unwrapping a flexible elongate delivery conduit from a storage position wrapped around a portion of a dispenser external housing connected with the flexible elongate delivery conduit at a fluid outlet in fluid communication with a canister of vehicle engine valve chemical cleaner,
attaching a support clip on a fluid delivery end of the flexible elongate delivery conduit;
clipping the support clip and fluid delivery end of the flexible elongate delivery conduit under an open hood of a vehicle to a vehicle engine intake manifold having vehicle engine intake valves to be cleaned;
extending the flexible elongate delivery conduit for a length of at least approximately 7 feet, together with the canister of vehicle engine valve chemical cleaner, to a driver seat location within a vehicle passenger compartment of the vehicle with the vehicle engine intake valves to be cleaned,
positioning the canister of vehicle engine valve chemical cleaner in one hand of a user seated in the driver seat location within the vehicle passenger compartment of the vehicle with the vehicle engine intake valves to be cleaned;
starting the vehicle engine using a second hand of the user seated in the driver seat location within the vehicle passenger compartment of the vehicle with the vehicle engine intake valves to be cleaned;
revving the vehicle engine to at least at least 2000-3500 RPM;
dispensing vehicle engine valve chemical cleaner into the vehicle engine by the user seated in the driver seat location within the vehicle passenger compartment of the vehicle with the vehicle engine intake valves to be cleaned activating a trigger on the dispenser external housing in fluid communication with the canister of vehicle engine valve chemical cleaner to spray vehicle engine valve chemical cleaner via the fluid delivery end of the flexible elongate delivery conduit supported by the support clip into the vehicle engine; and
ceasing activation of the trigger and ceasing revving of the vehicle engine by the user seated in the driver seat location within the vehicle passenger compartment of the vehicle with the vehicle engine intake valves to be cleaned once the canister of vehicle engine valve chemical cleaner is empty.

6. The method for cleaning vehicle engine intake valves of claim 5, comprising the further step of: providing the flexible elongate delivery conduit for a length of at least approximately 10 feet.

7. The method for cleaning vehicle engine intake valves of claim 5, comprising the further step of: providing the flexible elongate delivery conduit with a wire guide extending inside along or within a wall of the flexible elongate delivery conduit.

8. The method for cleaning vehicle engine intake valves of claim 5, comprising the further step of: providing the flexible elongate delivery conduit for a length of at least approximately 10 feet.

9. The method for cleaning vehicle engine intake valves of claim 5, comprising the further step of: providing the flexible elongate delivery conduit with a wire guide extending inside along or within a wall of the flexible elongate delivery conduit.

10. A system for cleaning vehicle engine intake valves, comprising:
a dispenser external housing connected with the flexible elongate delivery conduit having a length of at least approximately 7 to 10 feet extending from a non-removable attachment to a fluid outlet in fluid communication with a single use canister of vehicle engine valve chemical cleaner; and
a support clip secured on a fluid delivery end of the flexible elongate delivery conduit for clipping the support clip and fluid delivery end of the flexible elongate delivery conduit under an open hood of a vehicle to a vehicle engine intake manifold having vehicle engine intake valves to be cleaned.

11. The system of claim 10, wherein the flexible elongate delivery conduit includes a wire guide extending inside along or within a wall of the flexible elongate delivery conduit.

12. The system of claim 10, wherein the canister of vehicle engine valve chemical cleaner includes a sufficient percentage of water to enable a steam cleaning of the engine valves.
